(19) United States
(12) Patent Application Publication
(10) Pub. No.: US 2026/0280170 A1
(43) Pub. Date: Sep. 17, 2026

(54) HIGH CURRENT AND LOW PROFILE POWER CONNECTOR

(71) Applicant: FCI USA LLC, Etters, PA (US)

(72) Inventors: Ming Hsing Wu, Taoyuan City (TW); Yao-Ching Chiang, New Taipei City (TW); Chun Hsiang Fu, Taoyuan City (TW)

(73) Assignee: FCI USA LLC, Etters, PA (US)

(21) Appl. No.: 19/667,321

(22) Filed: May 4, 2026

Related U.S. Application Data
(60) Provisional application No. 63/901,474, filed on Oct. 17, 2025.

(51) Int. Cl. H01R 13/02; H01R 9/18; H01R 13/24; H01R 13/502; H01R 13/621

(52) U.S. Cl. CPC H01R 13/025; H01R 9/18; H01R 13/24; H01R 13/502; H01R 13/6215

(57) ABSTRACT

Electrical power connectors with compact depth, increased current capacity, and increased heat dissipation. An electrical connector includes one or more subassemblies each including a metal block. Fasteners engage cavities at a first surface of the metal block to couple an electrical terminal to the block. Other fasteners engage cavities at a second surface of the block to couple a conductor (e.g., a cable or busbar) to the block. The cavities at the first and second sides of the block (and their fasteners) are arranged with footprints that overlap each other. Because depth of the connector along its mating direction is partially determined by the fastener footprints, the depth of the connector is reduced by providing overlapping footprints. The width of the metal block may be large enough to receive the length of both sets of fasteners, so that the footprints can be overlapped without physical interference between fasteners.

### CROSS-REFERENCE TO RELATED APPLICATIONS

This application claims the benefit under 35 U.S.C 119(e) of U.S. Provisional Application Ser. No. 63/901,474, filed Oct. 17, 2025, under Attorney Docket No. A1156.70998US00, and entitled “HIGH CURRENT AND LOW PROFILE POWER CONNECTOR,” which is hereby incorporated herein by reference in its entirety.

### TECHNICAL FIELD

The present disclosure generally to electrical connectors, and in particular to electrical connectors for engaging with a busbar.

### BACKGROUND

The subject matter described and/or illustrated herein relates generally to electrical connectors that have opposing electrical contacts configured to engage opposite sides of a conductive component.

In some electrical systems, power is delivered to a circuit board or other electrical component through a busbar and a busbar connector. A busbar typically comprises a planar strip of conductive material (e.g., copper) having opposite sides which are engaged by the busbar connector. Busbar connectors can include a housing that holds two mating contacts that oppose each other with a space therebetween. When the busbar is inserted into the space, each of the mating contacts electrically engages a corresponding side of the busbar.

### SUMMARY

According to aspects of the disclosure, there is provided an electrical power connector assembly, comprising: a first electrical connector subassembly and a second electrical connector subassembly forming a slot configured to receive a complementary conductive power component, the first electrical connector subassembly comprising: a first metal block having a first surface and a second surface; a first electrical power terminal coupled to the first surface of the first metal block; and a first electrical power conductor coupled to the second surface of the first metal block; and the second electrical connector subassembly, comprising: a second metal block having a first surface and a second surface; a second electrical power terminal coupled to the first surface of the second metal block; and a second electrical power conductor coupled to the second surface of the second metal block.

Optionally, the first electrical power conductor comprises an electrical power cable assembly comprising: an electrical power cable; and a termination portion electrically coupled to the electrical power cable and mounted to the second surface of the first metal block.

Optionally, the electrical power connector assembly further comprises: a first plurality of fasteners holding the first electrical power terminal to the first surface of the first metal block; and a second plurality of fasteners holding the termination portion of the electrical power cable assembly to the second surface of the first metal block.

Optionally, the first surface of the first metal block has a first plurality of cavities extending into the first metal block from the first surface, the first plurality of cavities engaged with the first plurality of fasteners; and the second surface of the first metal block has a second plurality of cavities extending into the first metal block from the second surface, the first plurality of cavities engaged with the second plurality of fasteners.

Optionally, each cavity of the first plurality of cavities and the second plurality of cavities comprises a first plurality of threads; and each fastener of the first plurality of fasteners and the second plurality of fasteners comprises a second plurality of threads.

Optionally, the first surface of the first metal block and the second surface of the first metal block are parallel.

Optionally, a footprint of the first plurality of cavities of the first surface, when projected onto the second surface, overlaps with at least one cavity of the second plurality of cavities of the second surface.

Optionally, the first electrical power terminal comprises a contact portion arranged at the slot and a body portion, the body portion extending to a first edge opposite the contact portion; and the first surface of the first metal block extends to a second edge arranged adjacent to the first edge of the body portion of the first electrical power terminal.

Optionally, the electrical power connector assembly further comprises: an insulative housing comprising a protruding portion arranged around the slot; and a first ground and a second ground contact arranged each arranged outside of the slot, on an exterior surface of the protruding portion of the insulative housing.

According to aspects of the disclosure, there is provided a subassembly for electrical power connector assembly, the subassembly comprising: an electrical terminal; a metal block comprising: a first surface having a first plurality of cavities extending into the metal block from the first surface; and a second surface having a second plurality of cavities extending into the metal block from the second surface; and a first plurality of fasteners engaged with the first plurality of cavities of the first surface and holding the electrical terminal to the first surface of the metal block, wherein the second plurality of cavities of the second surface are configured to engage a second plurality of fasteners to hold an electrical cable assembly to the second surface of the metal block.

Optionally, the subassembly further comprises: the electrical cable assembly; and the second plurality of fasteners, wherein the second plurality of fasteners are engaged with the second plurality of cavities of the second surface and holding the electrical cable assembly to the second surface of the metal block.

Optionally, the electrical cable assembly comprises: an electrical power cable; and a termination portion electrically coupled to the electrical power cable and mounted to the second surface of the metal block.

Optionally, the first surface and the second surface of the metal block are parallel.

Optionally, a footprint of the first plurality of cavities of the first surface, when projected onto the second surface, overlaps with at least one cavity of the second plurality of cavities of the second surface.

Optionally, the electrical terminal comprises two or more metal plates pressed together by the first plurality of fasteners.

Optionally, each cavity of the first plurality of cavities and the second plurality of cavities comprises a first plurality of threads; and each fastener of the first plurality of fasteners and the second plurality of fasteners comprises a second plurality of threads.

Optionally, the electrical terminal comprises a contact portion and a body portion, the body portion extending to a first edge opposite the contact portion; and the first surface of the metal block extends to a second edge arranged adjacent to the first edge of the body portion of the electrical terminal.

According to aspects of the disclosure, there is provided a method of assembly an electrical power connector assembly comprising a metal block comprising a first surface and a second surface, the method comprising: mounting an electrical terminal to the first surface of the metal block using a first plurality of fasteners; and mounting an electrical cable assembly to the second surface of the metal block using a second plurality of fasteners.

Optionally, mounting the electrical terminal to the first surface of the metal block comprises engaging the first plurality of fasteners with a first plurality of cavities extending into the metal block from the first surface; and mounting the electrical cable assembly to the second surface of the metal block comprises engaging the second plurality of fasteners with a second plurality of cavities extending into the metal block from the second surface.

Optionally, the first surface and the second surface of the metal block are parallel; and engaging the first plurality of fasteners with the first plurality of cavities comprises engaging the first plurality of fasteners with the first plurality of cavities such that a footprint of the first plurality of fasteners, when projected onto the second surface, overlaps with at least one cavity of the second plurality of cavities of the second surface.

According to aspects of the disclosure, there is provided an electrical power connector system, comprising: a busbar comprising at least one electrical power layer, the at least one electrical power layer configured to transmit electrical power therethrough; and an electrical connector comprising a first electrical connector subassembly and a second electrical connector subassembly forming a slot, the first electrical connector subassembly comprising: a first metal block having a first surface and a second surface, wherein the first surface of the first metal block has a first plurality of cavities extending into the first metal block from the first surface and the second surface of the first metal block has a second plurality of cavities extending into the first metal block from the second surface; a first electrical power terminal; a first plurality of fasteners engaged with the first plurality of cavities and holding the first electrical power terminal to the first surface of the first metal block; a first electrical power conductor; and a second plurality of fasteners engaged with the second plurality of cavities and holding the first electrical power conductor to the second surface of the first metal block; and the second electrical connector subassembly, comprising: a second metal block having a first surface and a second surface; a second electrical power terminal coupled to the first surface of the second metal block; and a second electrical power conductor coupled to the second surface of the second metal block, wherein the electrical connector is configured to receive the busbar between the first electrical power conductor and the second electrical power conductor such that the at least one electrical power layer contacts at least one of the first electrical power conductor or the second electrical power conductor, wherein the first surface of the first metal block and the second surface of the first metal block are parallel, and wherein a footprint of the first plurality of cavities of the first surface of the first metal block, when projected onto the second surface of the first metal block, overlaps with at least one cavity of the second plurality of cavities of the second surface of the first metal block.

### BRIEF DESCRIPTION OF DRAWINGS

FIG. 1 shows an electrical power connector assembly, according to some embodiments;

FIG. 2 shows exposed subassemblies for the electrical power connector assembly of FIG. 1, according to some embodiments;

FIG. 3 shows an exploded view of the electrical power connector assembly of FIG. 1, according to some embodiments;

FIGS. 4A, 4B, 4C, and 4D show a metal block of a subassembly for the electrical power connector assembly of FIG. 1, according to some embodiments; and

FIGS. 5A and 5B show an electrical power terminal for the electrical power connector assembly of FIG. 1, according to some embodiments.

### DETAILED DESCRIPTION

According to aspects of the disclosure, there are provided electrical power connectors with compact depth, increased current capacity, and increased heat dissipation. An electrical connector includes one or more subassemblies each including a metal block. Fasteners engage cavities at a first surface of the metal block to couple an electrical terminal to the block. Other fasteners engage cavities at a second surface of the block to couple a conductor (e.g., a cable or busbar) to the block. The cavities at the first and second sides of the block (and their fasteners) are arranged with footprints that overlap each other. Because the depth of the connector along its mating direction is partially determined by the fastener footprints, the depth of the connector is reduced by providing overlapping footprints. The width of the metal block may be large enough to receive the length of both sets of fasteners, so that the footprints can be overlapped without physical interference between fasteners.

In some embodiments, the electrical connector may include two such subassemblies, and the subassemblies may be arranged to form a slot. The slot may be configured to receive a complementary conductive component such as a busbar. The electrical connector and the busbar may be electrical power components for transmitting high electric currents. Furthermore, the large size of the metal block provides additional conductive mass and cross section for increased current capacity and/or allows improved heat dissipation due to increased mass and greater surface area, as compared to conventional connectors.

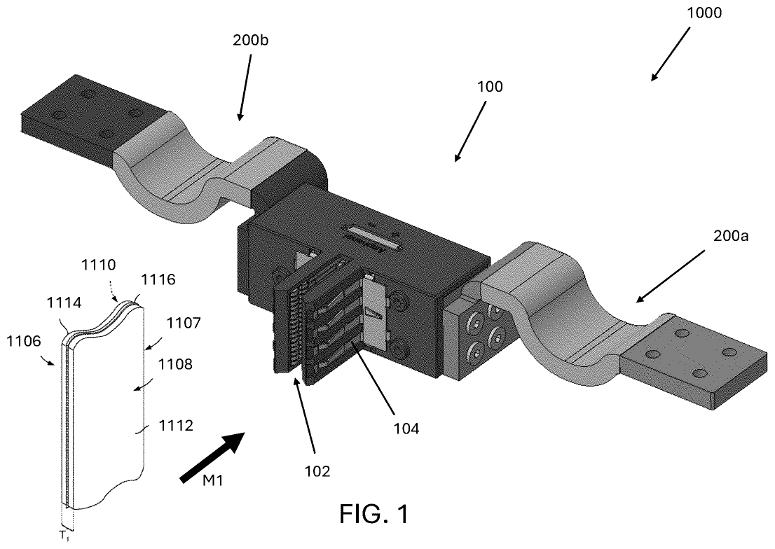

FIG. 1 shows an electrical power connector assembly, according to some embodiments. As shown in FIG. 1, an electrical connector assembly 1000 may include an electrical connector 100, electrical conductor assembly 200a, and electrical conductor assembly 200b. Electrical connector assembly 1000 may be an electrical power connector assembly configured for transmitting electrical power, and as such, electrical connector 100 may be an electrical power connector, and each of electrical conductor assembly 200a and 200b may be an electrical power conductor assembly.

As shown in FIG. 1, the electrical connector assembly 1000 may include a slot 102. The slot 102 may be configured for connecting with a complementary conductive component. The complementary conductive component may be configured for transmitting electrical power and may thus comprise a complementary conductive power component. In some embodiments, the one or more complementary conductive component may be a busbar. As shown in FIG. 1 the electrical connector assembly 1000 may further comprise one or more ground contacts 104 (discussed in more detail below). In some embodiments, each ground contact 104 may be arranged around and/or outside of the slot 102.

FIG. 1 also shows a conductive component 1106 that is configured to communicatively engage the electrical connector 100. The conductive component 1106 includes a leading edge 1107 that is configured to be received by the electrical connector 100. The conductive component 1106 may be a busbar. The electrical connector 100 may include electrical terminals 120 (described in more detail below) that are configured to transmit electrical power therethrough. However, in other embodiments, the conductive component 1106 may be, for example, a card connector and the electrical connector 100 may have electrical contacts configured to transmit data signals therethrough. Alternatively, the conductive component 1106 could be a printed circuit board with multiple conductive layers including two outer conductive layers that face in opposite directions.

The conductive component 1106 also has sides 1108 and 1110 and a thickness T1 extending therebetween. The sides 1108 and 1110 face in opposite directions along the thickness. The conductive component 1106 may be configured to be electrically engaged to the electrical connector 100 on each of side 1108 and 1110. In some embodiments, the conductive component 1106 comprises a busbar having multiple layers including power layers 1112 and 1114 and an insulative (e.g., dielectric layer) 1116 that is located between the power layers 1112 and 1114. The power layer 1112 includes the side 1108, and the power layer 1114 includes the side 1110. In an exemplary embodiment, the power layers 1112 and 1114 are electrically independent and capable of having different voltages. In some embodiments, the conductive component 1106 may have separate electrical contacts (e.g., contact pads) along the sides 1108 and 1110 that are capable of transmitting data signals. In an exemplary embodiment, the electrical terminals 120 are also electrically independent and capable of operating at different voltages. In other embodiments, conductive component 1106 may have a single conductor (e.g., a single piece of conductive material, such as copper, for example). The present application is not limited as to the composition of conductive component 1106, as the techniques and structures described herein may be used regardless of the composition of conductive component 1106 or the number of independent electrical terminals of conductive component 1106.

In some embodiments, the conductive component 1106 has an elongated and substantially rectangular-shaped body that is configured to be gripped on both of sides 1108 and 1110 by the electrical connector 100. In the illustrated embodiment, the slot 102 has a slot thickness sized to accommodate the thickness T1 of the conductive component 1106. For example, the slot thickness may be sized smaller than the thickness T1 such that terminals forming the slot bend when the conductive component 1106 is inserted into the slot. The bending of terminals may result in a complementary force being exerted on the conductive component 1106, and the complementary force may hold the conductive component 1106 in place within the slot. Accordingly, the slot 102 is configured to receive the conductive component 1106 when the leading edge 1107 of the conductive component 1106 is advanced into the slot 102 along a mating direction M1.

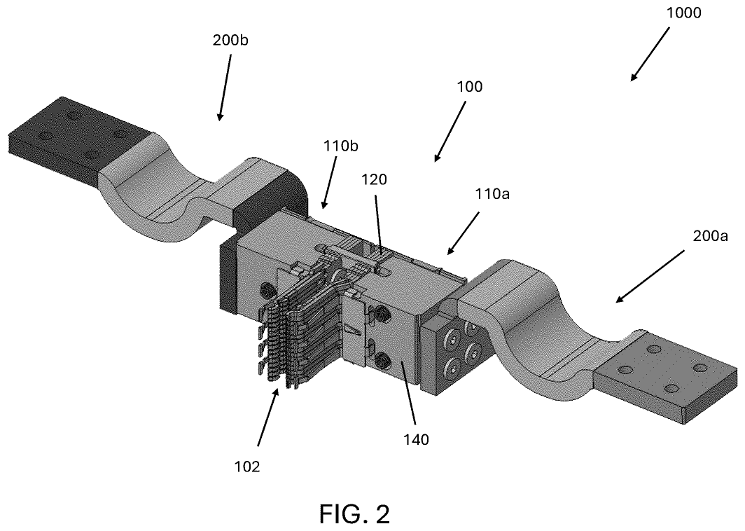

FIG. 2 shows exposed subassemblies for the electrical power connector assembly of FIG. 1, according to some embodiments. For example, FIG. 2 shows the electrical connector assembly 1000 with a housing (described in more detail below) of the electrical connector 100 not present, for illustration purposes. As shown in FIG. 2, the electrical connector 100 comprises a subassembly 110a and a subassembly 110b. When the electrical connector 100 comprises an electrical power connector, subassembly 110a and subassembly 110b may each comprise an electrical power subassembly. In the exemplary embodiment of FIG. 2, each of subassembly 110a and subassembly 110b comprises an electrical terminal 120 coupled with a metal block 140. As shown in FIG. 2, the electrical terminals 120 may in part form the slot 102. When either of subassembly 110a or subassembly 110b comprises an electrical power subassembly, the electrical terminal 120 may be an electrical power terminal, and the metal block 140 may be an electrical power conductor.

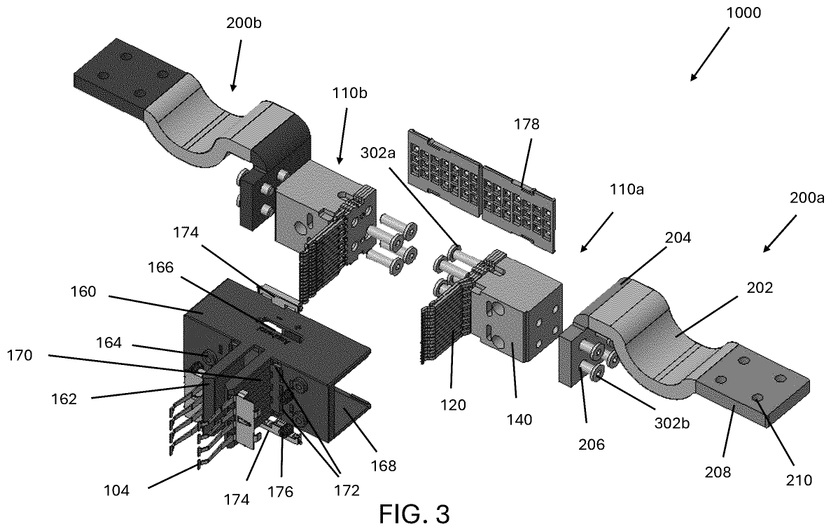

FIG. 3 shows an exploded view of the electrical power connector assembly of FIG. 1, according to some embodiments. The electrical connector 100 comprises the subassembly 110a and the subassembly 110b. Each subassembly may include two sets of fasteners. As shown in FIG. 3, there are first fasteners 302a configured to hold an electrical terminal 120 to a metal block 140, and second fasteners 302b configured to hold an electrical conductor assembly 200a or 200b to the metal block 140. The first fasteners 302a may extend through the openings 130 of the electrical terminals 120 into cavities 144a of the metal block 140. The second fasteners 302b may extend through the openings 206 of the termination portion 204 of the electrical conductor assembly 200a or 200b, into cavities 144b of the metal block 140. The openings and cavities and arrangements thereof are described in more detail below. In some embodiments, the first fasteners 302a and second fasteners 302b may be formed of a conductive material (such as metal), which may provide increased conductivity between the metal block 140 and components attached to the metal block.

The subassemblies 110a and 110b and their respective electrical conductor assemblies 200a and 200b may form opposite sides of a DC or AC power transfer connector. For example, subassembly 110a and electrical conductor assembly 200a may form a positive DC electrical side while subassembly 110b and electrical conductor assembly 200b may form a negative DC side. In some embodiments, subassembly 110a and electrical conductor assembly 200a may form a first AC side (e.g., hot side) while subassembly 110b and electrical conductor assembly 200b may form a second AC side (e.g., neutral side). It should be appreciated that the disclosure is not limited in this respect, and that subassemblies 110a and 110b and their respective electrical conductor assemblies 200a and 200b may be arranged in other power transfer configurations.

As shown in FIG. 3, each of electrical conductor assembly 200a and electrical conductor assembly 200b may comprise one or more electrical conductors 202 (e.g., a plurality of conductors), a termination portion 204, and a termination portion 208. Each electrical conductor 202 may be a busbar or an electrical cable. For example, conductor 202 may comprise a busbar with an insulator at least partially surrounding it. The insulator may comprise a heat shrink tube around a metal member of the busbar. The insulator provides insulation and protection of the busbar, e.g., by being configured to prevent accidental contact with foreign objects. The insulator may expose the termination portion 204 and the termination portion 208. Accordingly, electrical conductor assemblies 200a and 200b may be respective electrical cable assemblies. When either of electrical conductor assembly 200a or electrical conductor assembly 200b is an electrical power conductor assembly, an electrical conductor 202 may be an electrical power conductor or an electrical power cable.

The termination portion 204 and the termination portion 208 terminate the one or more electrical conductors 202 of each respective electrical conductor assembly. The termination portion may comprise a busbar connected to the electrical conductor 202. For example, the termination portion 204 and the termination portion 208 may be electrically and mechanically connected to the one or more electrical conductors 202, such as by one or more fasteners (not illustrated). Termination portion 204 may comprise openings 206, and termination portion 208 may comprise openings 210, each opening of which may receive a fastener (described below in more detail).

As shown in FIG. 3, electrical connector 100 includes a housing 160. The housing 160 may comprise an insulative material, such as a dielectric material. The housing 160 at least partially surrounds and insulates the assembly 100a and assembly 100b. The housing 160 may also include one or more rear portions 178 which are held covering a rear surface of the metal blocks 140. The housing 160 may further include openings 168 arranged such that a surface of the metal blocks 140 is exposed for engagement with a respective electrical conductor assembly.

In the illustrated embodiment, the housing 160 includes a protruding portion 162. The protruding portion in part forms the slot 102 along with the electrical terminals 120. At least one ground contact 104 may be arranged at or around the slot and/or the protruding portion. In some embodiments, the protruding portion 162 may include one or more recesses 170 configured to receive a ground contact 104. For example, a ground contact 104 may be held in the recesses 170 such that the ground contact lines an exterior of the protruding portion. The housing 160 may further include openings 172 configured to receive a portion of the ground contact 104. For example, the opening 172 may engage the ground contact to hold the ground contact 104.

Accordingly, when a complementary conductive component is received in the slot 102, the ground contact 104 may contact a complementary ground conductor of the conductive component. For example, when the complementary conductive component includes a busbar, the complementary ground conductor may include a ground shell surrounding the busbar. The ground shell of a busbar may comprise a conductive (e.g., metal) material that partially surrounds the busbar. The ground shell may comprise an opening configured to receive the protruding portion 162 of the housing 160, such that the protrusion portion can engage the busbar within the ground shell.

The housing 160 may include one or more fasteners 164 for coupling the housing to the electrical terminals 120 and/or metal blocks 140. For example, fasteners 176 may be inserted into a cavity (described in more detail below) of a metal block 140, and engaged with the fasteners 164. As such, the fasteners 164 and fasteners 176 may together hold the housing to the metal block 140.

As shown in FIG. 3, the housing may further comprise one or more spacer portions 174, which may be inserted into corresponding openings 166. As illustrated, the spacer portion 174 may engage with an engagement portion of an electrical terminal 120 (discussed in more detail below). When a spacer portion 174 is engaged with two of the electrical terminals 120, the engagement may prevent the electrical terminals 120 from contacting each other, by ensuring that a spacing is maintained between the electrical terminals 120.

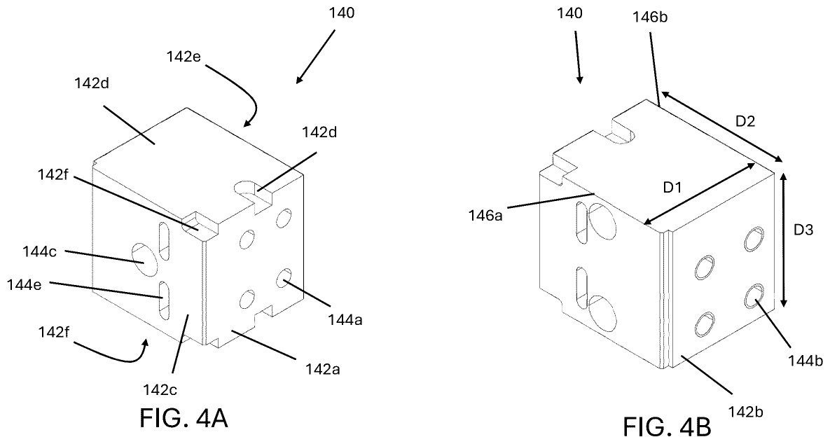

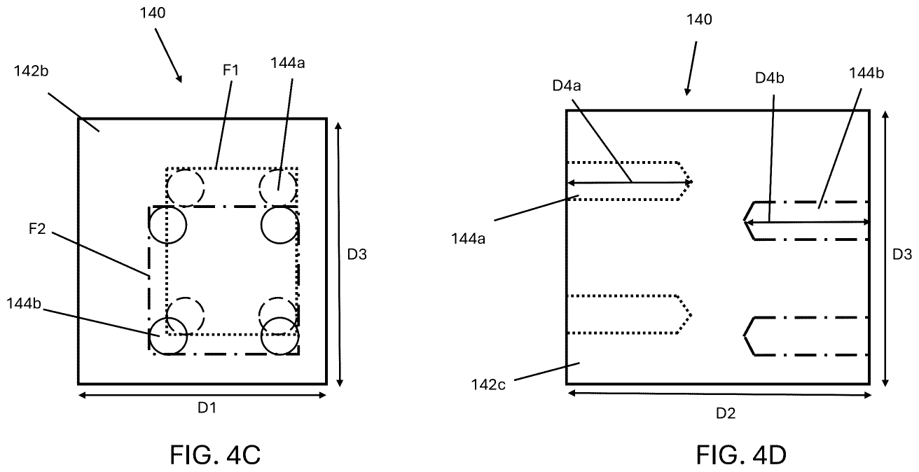

FIGS. 4A, 4B, and 4C show a metal block of a subassembly for the electrical power connector assembly of FIG. 1, according to some embodiments. FIGS. 4A and 4B show perspective views of a metal block 140. The metal block may have a cuboid arrangement. In a cuboid arrangement, the metal block includes six primary surfaces each arranged orthogonal to adjacent ones of the primary surfaces. As such, in the cuboid arrangement, opposite pairs of the faces may be parallel to each other. As shown in FIGS. 4A and 4B, the metal block 140 may include a first surface 142a arranged to face an electrical terminal 120, and a second surface 142b arranged to face an electrical conductor assembly 200a or 200b. The first surface 142a and the second surface 142b may be arranged on opposite sides of the metal block 140, and when the metal block 140 is cuboid, they may be parallel to each other, though in other embodiments they may be angled relative to each other. For example, the surfaces at which the cavities are arranged may instead be adjacent surfaces, which may be orthogonal when the metal block 140 is cuboid. The metal block 140 may further include a third surface 142c, a fourth surface 142d, a fifth surface 142e, and a sixth surface 142f, each of which may extend between the first surface 142a and the second surface 142b.

The first surface 142a may have cavities 144a extending into the metal block 140 from the first surface 142a. The cavities 144a are configured to receive first fasteners 302a. The cavities 144a may engage with the first fasteners 302a to hold an electrical terminal 120 to the metal block 140, which may mechanically and electrically connect the electrical terminal 120 and the metal block 140. Further, when the electrical terminal 120 comprises multiple metal plates (discussed in more detail below), the engagement of the cavities 144a and the first fasteners 302a may press the multiple metal plates together.

The second surface 142b may have cavities 144b extending into the metal block 140 from the second surface 142b. The cavities 144b are configured to receive second fasteners 302b. The cavities 144b may engage with the second fasteners 302b to hold an electrical conductor assembly 200a or 200b to the metal block 140, which may mechanically and electrically connect the electrical terminal 120 and electrical conductor assembly 200a or 200b. Further, when the electrical conductor assembly 200a or 200b comprises multiple electrical cables, the engagement of the cavities 144b and the second fasteners 302b may hold the multiple cables together.

Cavities described herein (such as cavities 144a and 144b) may comprise threads. Fasteners described herein (such as first fasteners 302a and second fasteners 302b) may comprise complementary threads configured to engage the threads of the cavities. As such, the fasteners may be screws or bolts and the cavities may be screw or bolt sockets.

The metal block 140 may comprise additional cavities that are arranged to accommodate other portions of the electrical connector assembly 1000. For example, cavities 144c may be configured to receive fasteners 176 to hold the housing 160 to the metal block, as discussed above. Cavities 144d may be configured to receive a portion of the spacer portion 174 so that the spacer portion 174 may engage with an electrical terminal 120 attached to the metal block 140. Further, cavities 144e and 144f may be aligned to receive a portion of the ground contacts 104. For example, cavities 144e and 144f may provide a spacing between the ground contacts 104 and the housing 160, or the cavities 144e and 144f may receive a portion of the housing 160 forming the openings 172 so that the ground contacts may be in contact with the housing 160 instead of the metal block 140. By forming the metal block 140 with the additional cavities described herein, the size of the electrical connector assembly 1000 may be reduced, because components can be partially inset into the metal blocks 140. As a result, a more compact connector assembly is provided.

A cuboid with dimensions of depth D1, width D2, and height D3 may surround the metal block 140. The depth D1 may refer to the depth of the metal block 140, extending from front edge 146a to rear edge 146b, which is aligned with the mating direction M1 of the slot. Depth D1 and height D3 may represent the approximate dimensions of the first surface 142a and the second surface 142b. According to aspects of the disclosure, a connector with a more compact depth D1 is provided by providing an increased width D2. Width D2 may be provided based on length of the first fasteners 302a and second fasteners 302b. In some embodiments, the width D2 may be approximately equal to, or slightly larger than the length of the first fasteners 302a added to the length of the second fasteners 302b. In some embodiments, the length of the fasteners may provide a width D2 that is greater than the depth D1. Height D3 may be substantially equal to depth D1. In some embodiments, the height D3 may be increased or decreased relative to a conventional connector. For example, overlapping the fasteners sets may allow the height D3 to be decreased as well as the depth D1. Alternatively or in addition to increasing the width D2 to accommodate two sets of fasteners, the height D3 may be increased to accommodate both sets.

The dimensions D1, D2, and D3 of the metal block 140, may provide electrical connector assembly 1000 with a low profile. In some embodiments, the depth D1 may be less than 40 mm, less than 35 mm, or less 30 mm. For example, D1 may be between 24 mm and 34 mm, between 26 mm and 32 mm, or between 28 mm and 30 mm. In some embodiments, the width D2 may be less than 45 mm, less than 40 mm, or 35 mm. For example, D2 may be greater than 5 mm, greater than 10 mm, greater than 20 mm, between 29 mm and 39 mm, between 31 mm and 37 mm, or between 33 mm and 35 mm. In some embodiments, the height D3 may be less than 40 mm, less than 35 mm, or 30 mm. For example, D3 may be between 26 mm and 36 mm, between 28 mm and 34 mm, or between 30 mm and 32 mm.

The depth D1 of the metal block may contribute the bulk of the depth of the electrical connector 100. For example, the metal block and the housing 160 may form the depth of the electrical connector 100. In some embodiments, the depth of the electrical connector 100 may be less than 42 mm, such as less than 37 mm or less than 35 mm. In contrast, a conventional connector may require a depth of approximately 45 mm to accommodate all the fasteners required to couple its terminals to electrical cables.

FIG. 4C shows footprints of the cavities of the metal block 140. FIG. 4C shows second surface 142b, with cavities 144b at the second surface 142b. The edges of second surface 142b and the edges of cavities 144b are shown in solid lines. For ease of illustration of the cavity footprints, the second surface 142b is shown as a rectangle with dimensions corresponding to depth D1 and height D3 of the metal block 140 (described in more detail below). Also shown in FIG. 4C is a projection of cavities 144a of first surface 142a, with the cavities 144a shown in dashed lines. Though FIG. 4C shows the second surface 142b, a reversed view showing first surface 142a with the cavities 144b of the second surface 142b projected onto the first surface 142a would yield a similar illustration as FIG. 4C. As such, the description of FIG. 4C and footprints, though illustrated for second surface 142b, is also applicable to first surface 142a.

FIG. 4C shows, in dotted lines, a footprint F1 of the cavities 144a. FIG. 4C also shows, in dashed-dotted lines, a footprint F2 of the cavities 144b. As shown in FIG. 4C, each footprint may surround its respective cavities. For example, the footprint may be formed by a smallest rectangle surrounding the cavities. Though FIG. 4C shows an example with 4 cavities for each footprint, a similar footprint may be formed by different numbers of cavities, e.g., with two, three, or a greater number of cavities. For embodiments with other than 4 cavities, the footprint may be formed by a smallest rectangle surrounding the cavities or may alternatively be formed by a smallest convex polygon surrounding the cavities, which may have a same number of sides as the number cavities. Moreover, though the footprints F1 and F2 are described above with respect to cavities, the first fasteners 302a and second fasteners 302b complementary to the cavities share the same footprints F1 and F2 when they are inserted into the cavities.

As shown in FIG. 4C, the footprints of the cavities may overlap when projected onto the opposite surface of the metal block 140. As shown in FIG. 4C, the footprints F1 and F2 overlap. Moreover, footprint F1 of the cavities 144a may overlap with at least one of the cavities 144b and the footprint F2 of the cavities 144b may overlap with at least one of the cavities 144a. For example, at least one of the footprints for one set of cavities may encircle at least one cavity of the other set of cavities. In addition, at least one cavity from one surface may overlap (including fully overlap) with at least one cavity of the other surface).

FIG. 4D shows depths of the cavities of the metal block 140. FIG. 4D shows third surface 142c of the metal block 140. The edges of third surface 142c are shown in solid lines. For ease of illustration of the cavity depths, the third surface 142c is shown as a rectangle with dimensions corresponding to width D2 and height D3 of the metal block 140 (described in more detail below), with, for example, additional cavities 144c, 144e, and 144f omitted.

Also shown in FIG. 4D is a projection of cavities 144a and 144b onto the third surface 142c, with the cavities 144a shown in dotted lines and cavities 144b shown in dashed-dotted lines. Though FIG. 4D shows the second surface 142c, views showing fourth surface 142d, fifth surface 142e, or sixth surface 142f with the cavities 144a and 144b onto those respective surfaces would yield a similar illustration as FIG. 4D. As such, the description of FIG. 4D and cavity depths, though illustrated for third surface 142b, is also applicable to fourth surface 142d, fifth surface 142e, or sixth surface 142f.

Cavities 144a may have depths D4a and cavities 144b may have depths D4b. In some embodiments, different ones of cavities 144a may have different depths and/or different ones of cavities 144b may have different depths. The depths D4a and D4b correspond to lengths of fasteners that are complementary to the respective cavities 144a and 144b. In some embodiments, the depth D4a may be substantially equal to the depth D4b.

As shown in FIG. 4D, the depths of the cavities 144a may not overlap with the depths of the cavities 144b. For example, depth D4a added to depth D4b may be equal to less than the width D2. In some embodiments, one or more of depth D4a or depth D4b may be less than half of the width D2. For example, one or more of the depth D4a or the depth D4b may be less than 16.9 mm, less than 16 mm, between 13.25 mm and 14.5 mm, between 13.5 mm and 14.25 mm, or between 13.75 mm and 14 mm. In some embodiments, one or more of the depth D4a or depth D4b may be equal to between 25% and 41.5%, between 29% and 37.5%, or between 32% and 35% of the width D2. In some embodiments, depth D4a added to depth D4b may equal to less than 99%, less than 95%, between 50% and 83%, between 58% and 75%, or between 64% and 70% of the width D2. In other embodiments, the depths of the cavities 144a may overlap with the depths of the cavities 144b.

The disclosure provides a compact arrangement of the electrical connector 100 as a result of the overlapping footprints of the metal block 140. For example, the electrical connector 100 may have a compact depth. In contrast, some conventional connectors may first fasten multiple metal plates of the terminal and then connect a cable directly to an electrical terminal. When the cable is fastened directly to the terminal, the cavities and the fasteners cannot be arranged with a compact depth. For example, because the electrical terminal includes multiple metal plates, the metal plates must be fastened together. After the metal plates are fastened together, the cable can be attached to the terminal. In some embodiments, 4 fasteners may be used at each attachment point, in order to provide a desired rigidity of the attachment. When 4 fasteners are used to couple the plates of the terminal and 4 fasteners are used to attach the cable, this results in the terminal including 8 cavities that accept the two sets of fasteners.

In such conventional connectors described above these two sets of holes increase the size of the terminals along the depth or other dimensions and thus increase the depth of the corresponding connector. Because both cavities must extend through the metal plate of a terminal, the cavities cannot overlap each other, because they would physically interfere. Thus, the depth of the terminal must be increased, resulting in a connector with a non-compact depth. Because the metal block provided by the disclosure allows the cavities and fasteners to overlap or even completely overlap with each other, the amount of depth along the mating direction M1 required to receive the fasteners is half that of a conventional connector. Thus, the depth of the body portion of the electrical terminals described herein can be reduced by up to half, compared with the depth of a conventional body portion, even when the same number of fasteners are used.

In addition, the large mass and cross-section of the metal block may enable the metal block to provide increased current capacity. Further, the surfaces of the metal block may provide a large contact area with each of electrical terminals 120 and the termination portions 204 which decreases electrical resistance between the electrical terminals and the termination portions. By using an increased number of fasteners for each connector (e.g., 4 or more fasteners), the attachment force between the metal block and each component may be increased, which may provide greater surface contact among the components of the electrical connector. The conductivity between the metal block and an attachment component may increase as additional fasteners are used for attachment. Increased conductivity may allow the connector to carry higher levels of current and/or may reduce the power loss of the electrical connector. The metal block may provide increased heat dissipation because it has a large mass to absorb heat and because it provides a large surface area exposed to an ambient in which the electrical connector is disposed. The metal block may be formed of a metal with high conductivity, such as copper or aluminum. For example, the metal block may be formed of high conductivity copper.

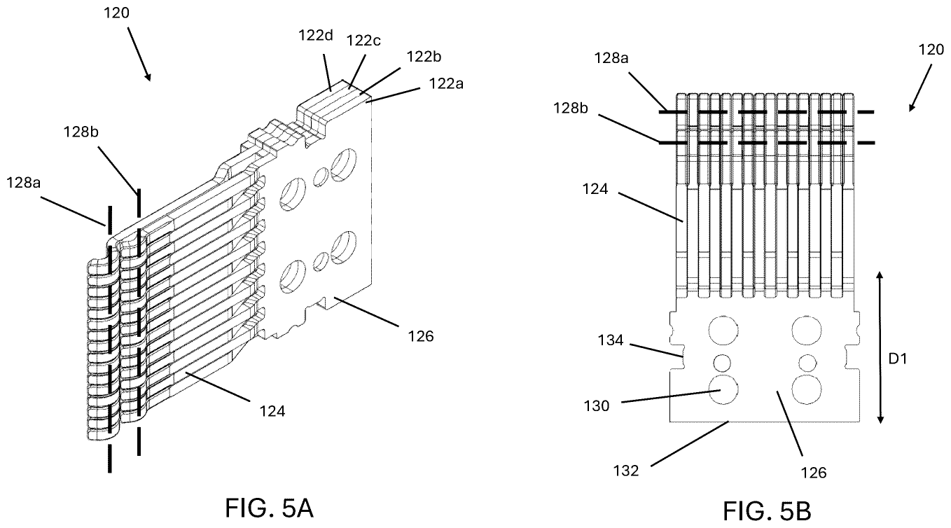

FIGS. 5A and 5B show an electrical power terminal for the electrical power connector assembly of FIG. 1, according to some embodiments. Electrical terminal 120 includes a contact portion 124 and a base portion 126. In some embodiments, the electrical terminal 120 may be formed of one metal plate, which may be pressed together by the engagement of the first fasteners 302a and the cavities 144a. As illustrated, the electrical terminal may also comprise multiple metal plates, such as metal plates 122a, 122b, 122c, and 122d. The contact portion 124 may comprise beams formed from the metal plates and may have one or more contact locations. In the exemplary embodiment of FIGS. 5A and 5B, the contact portion 124 comprises two contact locations, namely contact locations 128a and 128b. In other embodiments, the number of contact locations for each terminal may be one contact location, three contact locations, four contact locations, or more than four contact locations. Beams of each of the metal plates extend from the base portion 126 to one or more of the contact locations. For example, in the exemplary embodiment of FIGS. 5A and 5B, metal plates 122a and 122b comprise beams offset from each other that converge at the contact location 128b, and the metal plates 122c and 122d comprise beams offset from each other that converge at the contact location 128a. In some embodiments, one metal plate may have beams extending to two or more different contact locations. In the illustrative embodiment of FIGS. 5A and 5B, the contact location 128a may be arranged closer to an entrance of the slot 102 than the contact location 128b.

The base portion 126 of the electrical terminal 120 may comprise openings 130 configured to receive a first fastener 302a engaging with cavities 144a of the metal block 140. The base portion 126 may further comprise an engagement portion configured to engage with the spacer portion 174 of the housing 160, which may be used to space the electrical terminal 120 from other ones of the electrical terminals 120 of the electrical connector 100.

The electrical terminal 120 may extend to substantially the same depth as the metal block 140. As shown in FIG. 5B, the base portion 126 may include an edge 132. The edge 132 may be a rear edge of the electrical terminal 120. To provide a compact arrangement, the edge 132 of electrical terminal 120 may be arranged adjacent to the rear edge 146b of the metal block 140, such that the electrical terminal 120 and the metal block 140 extend to substantially the same depth. As shown in FIG. 5B, the depth D1 may be longer than the base portion 126 of the electrical terminal 120. Because the base portion is shorter than depth D1, the metal block may extend partially along the contact portion 124 (e.g., by extending partially along beams of the contact portion 124). By arranging the metal block 140 partially along the contact portion 124, the profile of the electrical connector 100 may be further reduced.

A method of assembling the electrical connector assembly 1000 may be carried out using the metal block 140. In a first step, an electrical terminal 120 may be mounted to the first surface 142a of the metal block 140 using the first fasteners 302a. In a second step, the electrical conductor assembly 200a may be mounted to the second surface 142b of the metal block 140 using the second fasteners 302b. The first step may include inserting the first fasteners 302a through the openings 130 of the electrical terminals 120, into the first cavities 144a of the metal block 140 and engaging the first fasteners with the first cavities. The second step may include inserting the second fasteners 302b through the openings 206 of the electrical conductor assembly 200a into the second cavities 144b of the metal block 140 and engaging the second fasteners with the second cavities. The first fasteners 302a and second fasteners 302b may be engaged with the metal block 140 such that their footprint in the metal block overlaps, according to the techniques described throughout the disclosure.

Having thus described several embodiments, it is to be appreciated various alterations, modifications, and improvements may readily occur to those skilled in the art. Such alterations, modifications, and improvements are intended to be within the spirit and scope of the invention.

Terms signifying direction, such as “upwards” and “downwards,” were used in connection with some embodiments. These terms were used to signify direction based on the orientation of components illustrated or connection to another component, such as a surface of a printed circuit board to which a termination assembly is mounted. It should be understood that electronic components may be used in any suitable orientation. Accordingly, terms of direction should be understood to be relative, rather than fixed to a coordinate system perceived as unchanging, such as the earth's surface.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, circuits and modules depicted and described may be reordered in any order, and signals may be provided to enable reordering accordingly.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

1. An electrical power connector assembly, comprising:
a first electrical connector subassembly and a second electrical connector subassembly forming a slot configured to receive a complementary conductive power component,
the first electrical connector subassembly comprising:
a first metal block having a first surface and a second surface;
a first electrical power terminal coupled to the first surface of the first metal block; and
a first electrical power conductor coupled to the second surface of the first metal block; and
the second electrical connector subassembly comprising:
a second metal block having a first surface and a second surface;
a second electrical power terminal coupled to the first surface of the second metal block; and
a second electrical power conductor coupled to the second surface of the second metal block.

2. The electrical power connector assembly of claim 1, wherein:
the first electrical power conductor comprises an electrical power cable assembly comprising:
an electrical power cable; and
a termination portion electrically coupled to the electrical power cable and mounted to the second surface of the first metal block.

3. The electrical power connector assembly of claim 2, further comprising:
a first plurality of fasteners holding the first electrical power terminal to the first surface of the first metal block; and
a second plurality of fasteners holding the termination portion of the electrical power cable assembly to the second surface of the first metal block.

4. The electrical power connector assembly of claim 3, wherein:
the first surface of the first metal block has a first plurality of cavities extending into the first metal block from the first surface, the first plurality of cavities engaged with the first plurality of fasteners; and
the second surface of the first metal block has a second plurality of cavities extending into the first metal block from the second surface, the first plurality of cavities engaged with the second plurality of fasteners.

5. The electrical power connector assembly of claim 4, wherein:
each cavity of the first plurality of cavities and the second plurality of cavities comprises a first plurality of threads; and
each fastener of the first plurality of fasteners and the second plurality of fasteners comprises a second plurality of threads.

6. The electrical power connector assembly of claim 4, wherein:
the first surface of the first metal block and the second surface of the first metal block are parallel; and
a footprint of the first plurality of cavities of the first surface, when projected onto the second surface, overlaps with at least one cavity of the second plurality of cavities of the second surface.

7. The electrical power connector assembly of claim 5, wherein:
the first surface of the first metal block and the second surface of the first metal block are spaced from each other at a width along a first direction;
the first plurality of cavities extend into the first metal block from the first surface with a first depth along the first direction;
the second plurality of cavities extend into the first metal block from the second surface to a second depth along the first direction; and
the first depth added to the second depth is equal to less than the width.

8. The electrical power connector assembly of claim 7, wherein:
the first depth added to the second depth is equal to between 50% and 83% of the width.

9. The electrical power connector assembly of claim 1, wherein:
the first electrical power terminal comprises a contact portion arranged at the slot and a body portion, the body portion extending to a first edge opposite the contact portion; and
the first surface of the first metal block extends to a second edge arranged adjacent to the first edge of the body portion of the first electrical power terminal.

10. The electrical power connector assembly of claim 1, further comprising:
an insulative housing comprising a protruding portion arranged around the slot; and
a first ground and a second ground contact arranged each arranged outside of the slot, on an exterior surface of the protruding portion of the insulative housing.

11. A subassembly for electrical power connector assembly, the subassembly comprising:
an electrical terminal;
a metal block comprising:
a first surface having a first plurality of cavities extending into the metal block from the first surface; and
a second surface having a second plurality of cavities extending into the metal block from the second surface; and
a first plurality of fasteners engaged with the first plurality of cavities of the first surface and holding the electrical terminal to the first surface of the metal block,
wherein the second plurality of cavities of the second surface are configured to engage a second plurality of fasteners to hold an electrical cable assembly to the second surface of the metal block.

12. The subassembly of claim 11, further comprising:
the electrical cable assembly; and
the second plurality of fasteners,
wherein the second plurality of fasteners are engaged with the second plurality of cavities of the second surface and holding the electrical cable assembly to the second surface of the metal block.

13. The subassembly of claim 12, wherein:
the electrical cable assembly comprises:
an electrical power cable; and
a termination portion electrically coupled to the electrical power cable and mounted to the second surface of the metal block.

14. The subassembly of claim 11, wherein:
the first surface and the second surface of the metal block are parallel; and
a footprint of the first plurality of cavities of the first surface, when projected onto the second surface, overlaps with at least one cavity of the second plurality of cavities of the second surface.

15. The subassembly of claim 11, wherein:
the electrical terminal comprises two or more metal plates pressed together by the first plurality of fasteners.

16. The subassembly of claim 11, wherein:
the electrical terminal comprises a contact portion and a body portion, the body portion extending to a first edge opposite the contact portion; and
the first surface of the metal block extends to a second edge arranged adjacent to the first edge of the body portion of the electrical terminal.

17. A method of assembling an electrical power connector assembly comprising a metal block comprising a first surface and a second surface, the method comprising:
mounting an electrical terminal to the first surface of the metal block using a first plurality of fasteners; and
mounting an electrical cable assembly to the second surface of the metal block using a second plurality of fasteners.

18. The method of claim 17, wherein:
mounting the electrical terminal to the first surface of the metal block comprises engaging the first plurality of fasteners with a first plurality of cavities extending into the metal block from the first surface; and
mounting the electrical cable assembly to the second surface of the metal block comprises engaging the second plurality of fasteners with a second plurality of cavities extending into the metal block from the second surface.

19. The method of claim 18, wherein:
the first surface and the second surface of the metal block are parallel; and
engaging the first plurality of fasteners with the first plurality of cavities comprises engaging the first plurality of fasteners with the first plurality of cavities such that a footprint of the first plurality of fasteners, when projected onto the second surface, overlaps with at least one cavity of the second plurality of cavities of the second surface.

20. An electrical power connector system, comprising:
a busbar comprising at least one electrical power layer, the at least one electrical power layer configured to transmit electrical power therethrough; and
an electrical connector comprising a first electrical connector subassembly and a second electrical connector subassembly forming a slot,
the first electrical connector subassembly comprising:
a first metal block having a first surface and a second surface, wherein the first surface of the first metal block has a first plurality of cavities extending into the first metal block from the first surface and the second surface of the first metal block has a second plurality of cavities extending into the first metal block from the second surface;
a first electrical power terminal;
a first plurality of fasteners engaged with the first plurality of cavities and holding the first electrical power terminal to the first surface of the first metal block;
a first electrical power conductor; and
a second plurality of fasteners engaged with the second plurality of cavities and holding the first electrical power conductor to the second surface of the first metal block; and
the second electrical connector subassembly comprising:
a second metal block having a first surface and a second surface;
a second electrical power terminal coupled to the first surface of the second metal block; and
a second electrical power conductor coupled to the second surface of the second metal block,
wherein the electrical connector is configured to receive the busbar in the slot between the first electrical power conductor and the second electrical power conductor such that the at least one electrical power layer contacts at least one of the first electrical power conductor or the second electrical power conductor,
wherein the first surface of the first metal block and the second surface of the first metal block are parallel, and
wherein a footprint of the first plurality of cavities of the first surface of the first metal block, when projected onto the second surface of the first metal block, overlaps with at least one cavity of the second plurality of cavities of the second surface of the first metal block.
